(19) United States
(12) Patent Application Publication
(10) Pub. No.: US 2013/0049899 A1
(43) Pub. Date: Feb. 28, 2013

(54) WINDOWS IN CONDUCTIVE COVERINGS OF DIELECTRIC BODIES FOR FILTERS

(71) Applicants: David Robert HENDRY, Brisbane (AU); Steven John Cooper, Brisbane (AU); Peter Blakeborough Kenington, Chepstow (GB)

(72) Inventors: David Robert HENDRY, Brisbane (AU); Steven John Cooper, Brisbane (AU); Peter Blakeborough Kenington, Chepstow (GB)

(73) Assignee: MESAPLEXX PTY LTD, Eight Mile Plains (AU)

(21) Appl. No.: 13/593,049

(22) Filed: Aug. 23, 2012

Related U.S. Application Data
(60) Provisional application No. 61/531,277, filed on Sep. 6, 2011.

(30) Foreign Application Priority Data
Aug. 23, 2011 (AU) 2011903389

(51) Int. Cl. H01P 1/20

(52) U.S. Cl. 333/202; 333/219.1

(57) ABSTRACT

A multi-mode cavity filter has a resonator body with a face and a conductive covering. The face has an uncovered area through which a signal can be coupled into or out of the body. A boundary exists between the uncovered area and the covering. A first vector drawn between two most distal points on the boundary and not crossing the covering is such that a second vector drawn between two other points on the boundary and orthogonal to the first vector has a length that is at least 70% that of the first vector. The length of the first vector is at least 20% of the length of the shortest vector that passes through a centroid of the face and extends completely across the face.

### CROSS-REFERENCE TO RELATED APPLICATIONS

The present application is related to and claims the benefit of Australian Provisional Patent Application No. 2011903389, filed Aug. 23, 2011 and U.S. Provisional Patent Application No. 61/531,277, filed Sep. 6, 2011, both of whose disclosures are hereby incorporated by reference in their entirety into the present disclosure.

### BACKGROUND

The present invention relates to a multi-mode filter, and in particular to a multi-mode filter including a resonator body, for use, for example in frequency division duplexers for telecommunication applications.

### DESCRIPTION OF PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

All physical filters essentially consist of a number of energy storing resonant structures, with paths for energy to flow between the various resonators and between the resonators and the input/output ports. The physical implementation of the resonators and the manner of their interconnections will vary from type to type, but the same basic concept applies to all. Such a filter can be described mathematically in terms of a network of resonators coupled together, although the mathematical topography does not have to match the topography of the real filter.

Conventional single-mode filters formed from dielectric resonators are known. Dielectric resonators have high-Q (low loss) characteristics which enable highly selective filters having a reduced size compared to cavity filters. These single-mode filters tend to be built as a cascade of separated physical dielectric resonators, with various couplings between them and to the ports. These resonators are easily identified as distinct physical objects, and the couplings tend also to be easily identified.

Single-mode filters of this type may include a network of discrete resonators formed from ceramic materials in a “puck” shape, where each resonator has a single dominant resonance frequency, or mode. These resonators are coupled together by providing openings between cavities in which the resonators are located. Typically, the resonators provide transmission poles or “zeros”, which can be tuned at particular frequencies to provide a desired filter response. A number of resonators will usually be required to achieve suitable filtering characteristics for commercial applications, resulting in filtering equipment of a relatively large size.

One example application of filters formed from dielectric resonators is in frequency division duplexers for microwave telecommunication applications. Duplexers have traditionally been provided at base stations at the bottom of antenna supporting towers, although a current trend for microwave telecommunication system design is to locate filtering and signal processing equipment at the top of the tower to thereby minimise cabling lengths and thus reduce signal losses. However, the size of single mode filters as described above can make these undesirable for implementation at the top of antenna towers.

Multimode filters implement several resonators in a single physical body, such that reductions in filter size can be obtained. As an example, a silvered dielectric body can resonate in many different modes. Each of these modes can act as one of the resonators in a filter. In order to provide a practical multimode filter it is necessary to couple the energy between the modes within the body, in contrast with the coupling between discrete objects in single mode filters, which is easier to control in practice.

The usual manner in which these multimode filters are implemented is to selectively couple the energy from an input port to a first one of the modes. The energy stored in the first mode is then coupled to different modes within the resonator by introducing specific defects into the shape of the body. In this manner, a multimode filter can be implemented as an effective cascade of resonators, in a similar way to conventional single mode filter implementations. Again, this technique results in transmission poles which can be tuned to provide a desired filter response.

An example of such an approach is described in U.S. Pat. No. 6,853,271, which is directed towards a triple-mode mono-body filter. Energy is coupled into a first mode of a dielectric-filled mono-body resonator, using a suitably configured input probe provided in a hole formed on a face of the resonator. The coupling between this first mode and two other modes of the resonator is accomplished by selectively providing corner cuts or slots on the resonator body.

This technique allows for substantial reductions in filter size because a triple-mode filter of this type represents the equivalent of a single-mode filter composed of three discrete single mode resonators. However, the approach used to couple energy into and out of the resonator, and between the modes within the resonator to provide the effective resonator cascade, requires the body to be of complicated shape, increasing manufacturing costs.

Two or more triple-mode filters may still need to be cascaded together to provide a filter assembly with suitable filtering characteristics. As described in U.S. Pat. Nos. 6,853,271 and 7,042,314 this may be achieved using a waveguide or aperture for providing coupling between two resonator mono-bodies. Another approach includes using a single-mode comb-line resonator coupled between two dielectric mono-bodies to form a hybrid filter assembly as described in U.S. Pat. No. 6,954,122. In any case the physical complexity and hence manufacturing costs are even further increased.

### SUMMARY

According to some embodiments, the invention provides A multi-mode cavity filter, comprising: a resonator body of dielectric material capable of supporting at least two degenerate electromagnetic standing wave modes and having a face; and a conductive covering extending over all of the resonator body except a part of the face so that the covering defines an uncovered area on the face through which a signal can be at least one of coupled into and coupled out of the body; wherein: there is a boundary between the uncovered area and the covering and bounding the uncovered area; a first vector exists that is the longest vector that can be drawn between two points on the boundary without crossing any of the covering; a second vector exists that extends in a direction orthogonal to the first vector and which is the largest vector that can be drawn in that direction between two points on the boundary without crossing any of the covering; the covering is arranged so that the length of the second vector is at least 70% of the length of the first vector; and the covering is arranged such that the length of the first vector is at least 20% of the length of the shortest vector that passes through the centroid of the face and extends completely across the face.

In some embodiments, the geometry of the boundary is such that the first vector is one of a plurality of vectors of the same length that can be drawn between two points on the boundary without crossing any of the covering, e.g. when the uncovered area is square, circular or a regular polygon. In some embodiments, the first and second vectors have the same length, e.g. when the uncovered area is circular.

### BRIEF DESCRIPTION OF THE DRAWINGS

An example of the present invention will now be described with reference to the accompanying drawings, in which:

FIG. 1A is a schematic perspective view of an example of a multi-mode filter;

FIG. 1B is a schematic side view of the multi-mode filter of FIG. 1A;

FIG. 1C is a schematic plan view of the multi-mode filter of FIG. 1A;

FIG. 1D is a schematic plan view of an example of the substrate of FIG. 1A including a coupling structure;

FIG. 1E is a schematic underside view of an example of the substrate of FIG. 1A including inputs and outputs;

FIGS. 2A to 2C are schematic diagrams of examples the resonance modes of the resonator body of FIG. 1A;

FIG. 3A is a schematic perspective view of an example of a specific configuration of a multi-mode filter;

FIG. 3B is a graph of an example of the frequency response of the filter of FIG. 3A;

FIGS. 4A to 4F are schematic plan views of example coupling structures;

FIG. 5 is a schematic diagram of an example of a filter network model for the filter of FIGS. 1A to 1E;

FIGS. 6A to 6C are schematic plan views of example couplings illustrating how coupling configuration impacts on coupling constants of the filter;

FIGS. 7A to 7E are schematic plan views of example of alternative coupling structures for the filter of FIGS. 1A to 1E;

FIG. 8A is a schematic side view of an example of a multi-mode filter using multiple resonator bodies;

FIG. 8B is a schematic plan view of an example of the substrate of FIG. 8A including multiple coupling structures;

FIG. 8C is a schematic internal view of an example of the substrate of FIG. 8A including inputs and outputs;

FIG. 8D is a schematic underside view of an example of the substrate of FIG. 8A;

FIG. 8E is a schematic diagram of an example of a filter network model for the filter of FIGS. 8A to 8D;

FIG. 9A is a schematic diagram of an example of a duplex communications system incorporating a multi-mode filter;

FIG. 9B is a schematic diagram of an example of the frequency response of the multi-mode filter of FIG. 9A;

FIG. 9C is a schematic diagram of an example of a filter network model for the filter of FIG. 9A;

FIG. 10A is a schematic perspective view of an example of a multi-mode filter using multiple resonator bodies to provide filtering for transmit and receive channels;

FIG. 10B is a schematic plan view of an example of the substrate of FIG. 10A including multiple coupling structures;

FIG. 10C is a schematic underside view of an example of the substrate of FIG. 10A including inputs and outputs;

FIG. 11 is a cross section through a filter;

FIG. 12 is a cross section through another filter;

FIG. 13 is a schematic illustration of a window in a coating on a face of a resonator body;

FIG. 14 is a simplified illustration of the face shown in FIG. 13;

FIG. 15 is an illustration of a different window that could be used on the face shown in FIG. 13;

FIG. 16 is an illustration of yet another window that could be used on the face shown in FIG. 13;

FIG. 17 is an illustration of current flows in a conductive covering on the face of a dielectric resonator in a first standing wave mode of the resonator;

FIG. 18 is an illustration of current flows in a conductive covering on the face of a dielectric resonator in a second standing wave mode of the resonator; and

FIG. 19 is an illustration of current flows in a conductive covering on the face of a dielectric resonator in a third standing wave mode of the resonator.

### DETAILED DESCRIPTION

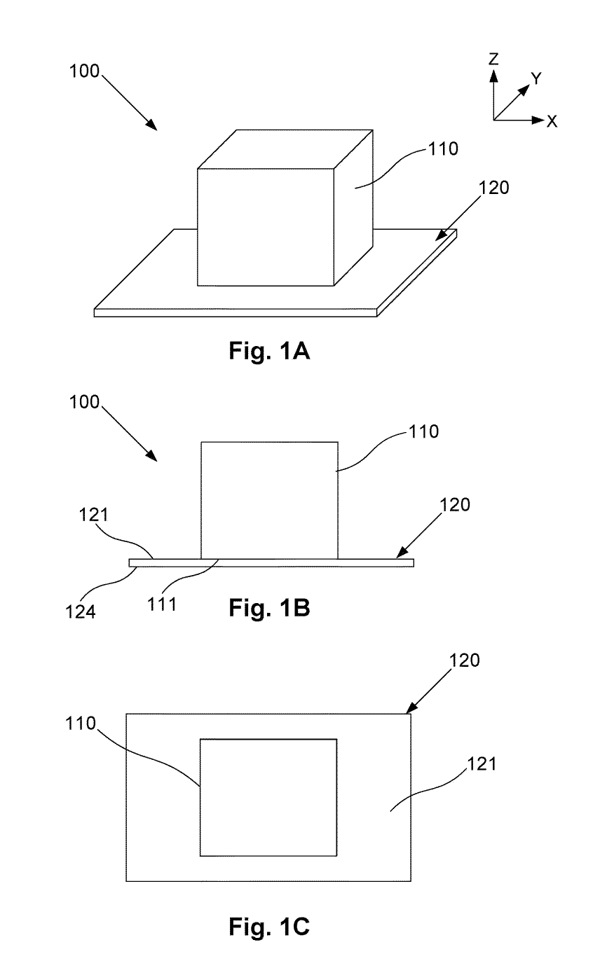

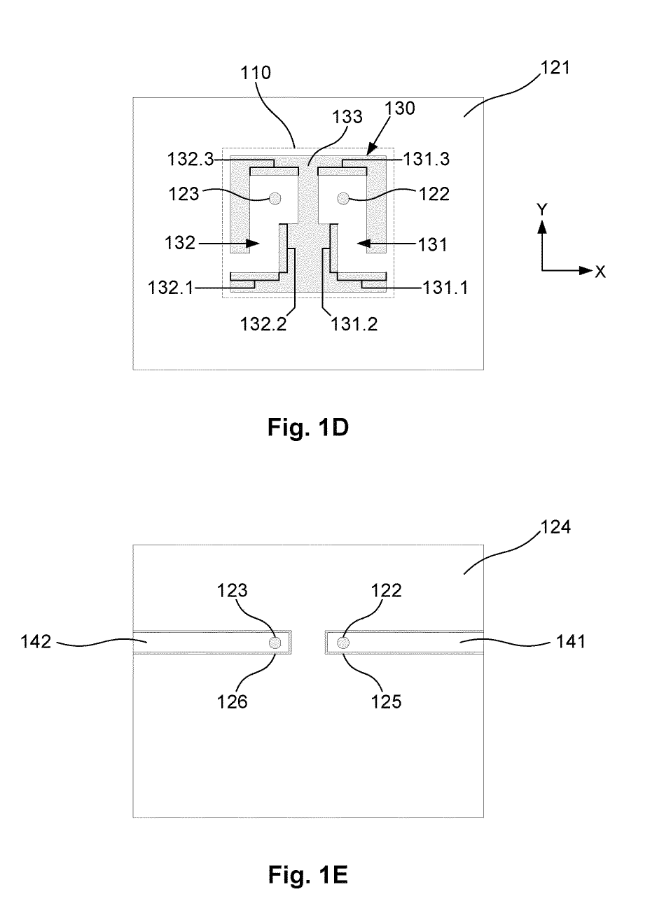

An example of a multi-mode filter will now be described with reference to FIGS. 1A to 1E.

In this example, the filter 100 includes a resonator body 110, and a coupling structure 130. The coupling structure 130 at least one coupling 131, 132, which includes an electrically conductive coupling path extending adjacent at least part of a surface 111 of the resonator body 110, so that the coupling structure 130 provides coupling to a plurality of the resonance modes of the resonator body.

In use, a radio frequency signal, containing, say, frequencies from within the 1 MHz to 100 GHz range, can be supplied to or received from the at least one coupling 131, 132. In a suitable configuration, this allows a signal to be filtered to be supplied to the resonator body 110 for filtering, or can allow a filtered signal to be obtained from the resonator body, as will be described in more detail below.

The use of electrically conductive coupling paths 131, 132 extending adjacent to the surface 111 allows the signal to be coupled to a plurality of resonance modes of the resonator body 110. This allows a more simplified configuration of resonator body 110 and coupling structures 130 to be used as compared to traditional arrangements. For example, this avoids the need to have a resonator body including cut-outs or other complicated shapes, as well as avoiding the need for coupling structures that extend into the resonator body. This, in turn, makes the filter cheaper and simpler to manufacture, and can provide enhanced filtering characteristics. In addition, the filter is small in size, typically of the order of 6000 mm³ per resonator body, making the filter apparatus suitable for use at the top of antenna towers.

A number of further features will now be described.

In the above example, the coupling structure 130 includes two couplings 131, 132, coupled to an input 141, an output 142, thereby allowing the couplings to act as input and output couplings respectively. In this instance, a signal supplied via the input 141 couples to the resonance modes of the resonator body 110, so that a filtered signal is obtained via the output 142. However, the use of two couplings is for the purpose of example only, and one or more couplings may be used depending on the preferred implementation.

For example, a single coupling 131, 132 may be used if a signal is otherwise coupled to the resonator body 110. This can be achieved if the resonator body 110 is positioned in contact with, and hence is coupled to, another resonator body, thereby allowing signals to be received from or supplied to the other resonator body. Coupling structures may also include more couplings, for example if multiple inputs and/or outputs are to be provided, although alternatively multiple inputs and/or outputs may be coupled to a single coupling, thereby allowing multiple inputs and/or outputs to be accommodated.

Alternatively, multiple coupling structures 130 may be provided, with each coupling structure 130 having one or more couplings. In this instance, different coupling structures can be provided on different surfaces of the resonator body. A further alternative is for a coupling structure to extend over multiple surfaces of the resonator body, with different couplings being provided on different surfaces, or with couplings extending over multiple surfaces. Such arrangements can be used to allow a particular configuration of input and output to be accommodated, for example to meet physical constraints associated with other equipment, or to allow alternative coupling arrangements to be provided. In use, a configuration of the input and output coupling paths 131, 132, along with the configuration of the resonator body 110 controls a degree of coupling with each of the plurality of resonance modes and hence the properties of the filter, such as the frequency response.

The degree of coupling depends on a number of factors, such as a coupling path width, a coupling path length, a coupling path shape, a coupling path direction relative to the resonance modes of the resonator body, a size of the resonator body, a shape of the resonator body and electrical properties of the resonator body. It will therefore be appreciated that the example coupling structure and cube configuration of the resonator body is for the purpose of example only, and is not intended to be limiting.

Typically the resonator body 110 includes, and more typically is manufactured from a solid body of a dielectric material having suitable dielectric properties. In one example, the resonator body is a ceramic material, although this is not essential and alternative materials can be used. Additionally, the body can be a multilayered body including, for example, layers of materials having different dielectric properties. In one example, the body can include a core of a dielectric material, and one or more outer layers of different dielectric materials.

The resonator body 110 usually includes an external coating of conductive material, such as silver, although other materials could be used such as gold, copper, or the like. The conductive material may be applied to one or more surfaces of the body. A region of the surface adjacent the coupling structure may be uncoated to allow coupling of signals to the resonator body.

The resonator body can be any shape, but generally defines at least two orthogonal axes, with the coupling paths extending at least partially in the direction of each axis, to thereby provide coupling to multiple separate resonance modes.

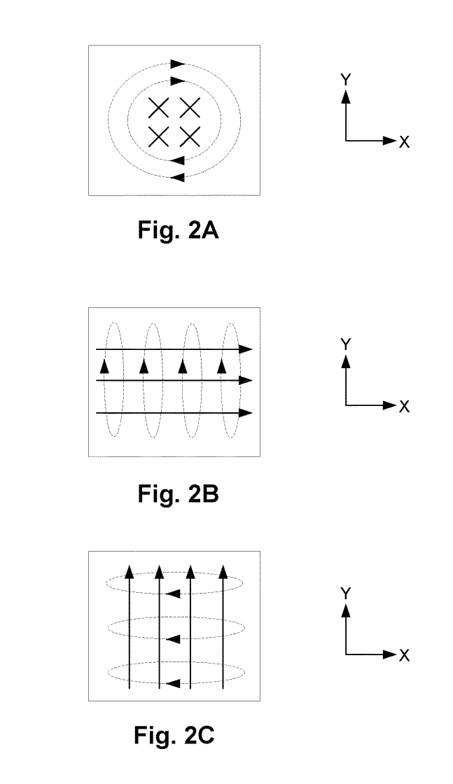

In the current example, the resonator body 110 is a cuboid body, and therefore defines three orthogonal axes substantially aligned with surfaces of the resonator body, as shown by the axes X, Y, Z. As a result, the resonator body 110 has three dominant resonance modes that are substantially orthogonal and substantially aligned with the three orthogonal axes. Examples of the different resonance modes are shown in FIGS. 2A to 2C, which show magnetic and electrical fields in dotted and solid lines respectively, with the resonance modes being generally referred to as TM110, TE011 and TE101 modes, respectively.

In this example, each coupling path 131, 132 includes a first path 131.1, 132.1 extending in a direction parallel to a first axis of the resonator body, and a second path 131.2, 132.2, extending in a direction parallel to a second axis orthogonal to the first axis. Each coupling path 131, 132 also includes an electrically conductive coupling patch 131.3, 132.3.

Thus, with the surface 111 provided on an X-Y plane, each coupling includes first and second paths 131.1, 131.2, 132.1, 132.2, extending in a plane parallel to the X-Y plane and in directions parallel to the X and Y axes respectively. This allows the first and second paths 131.1, 131.2, 132.1, 132.2 to couple to first and second resonance modes of the resonator body 110. The coupling patch 131.1, 131.2, defines an area extending in the X-Y plane and is for coupling to at least a third mode of the resonator body, as will be described in more detail below.

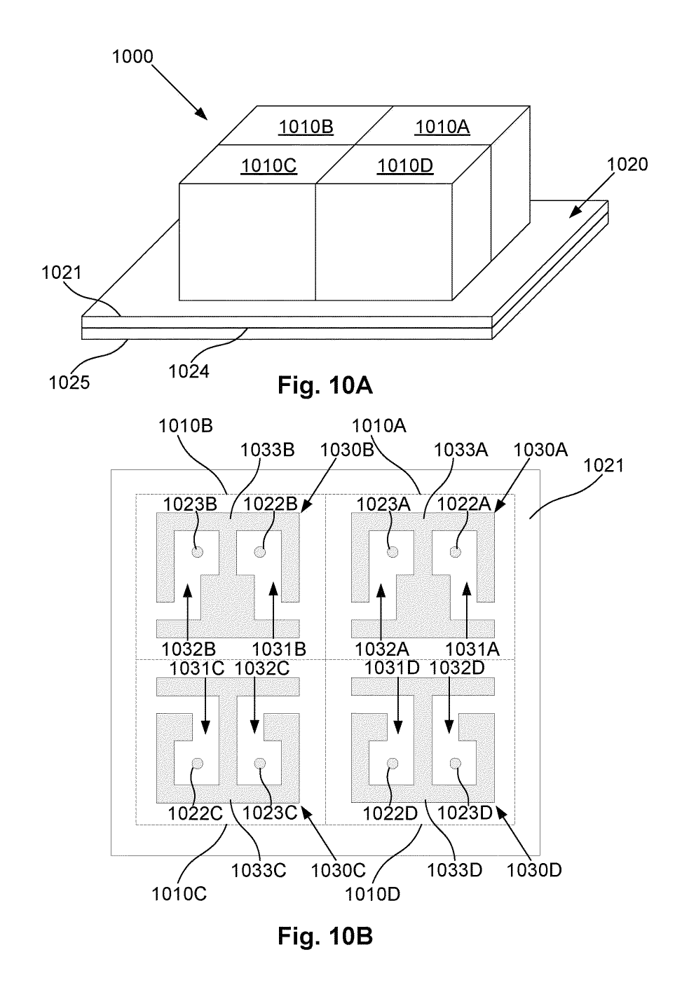

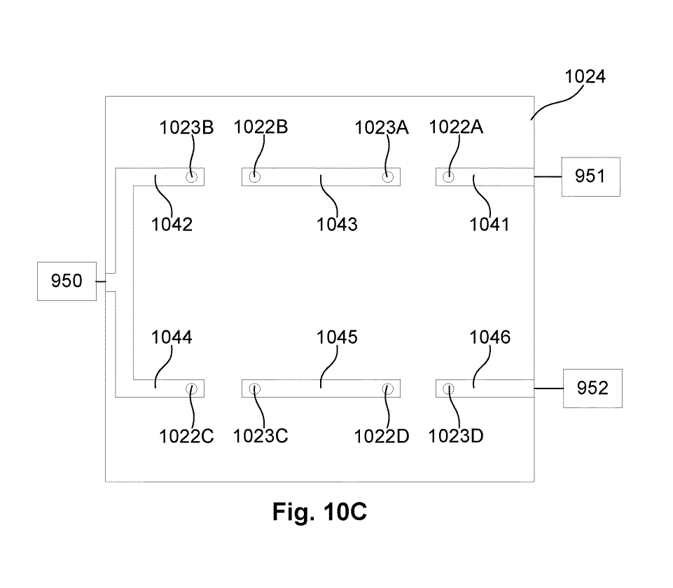

Cuboid structures are particularly advantageous as they can be easily and cheaply manufactured, and can also be easily fitted together, for example by arranging multiple resonator bodies in contact, as will be described below with reference to FIG. 10A. Cuboid structures typically have clearly defined resonance modes, making configuration of the coupling structure more straightforward. Additionally, the use of a cuboid structure provides a planar surface 111 so that the coupling paths can be arranged in a plane parallel to the planar surface 111, with the coupling paths optionally being in contact with the resonator body 110. This can help maximise coupling between the couplings and resonator body 110, as well as allowing the coupling structure 130 to be more easily manufactured.

For example, the couplings may be provided on a substrate 120. In this instance, the provision of a planar surface 111 allows the substrate 120 to be a planar substrate, such as a printed circuit board (PCB) or the like, allowing the coupling paths 131, 132 to be provided as conductive paths on the PCB. However, alternative arrangements can be used, such as coating the coupling structures onto the resonator body directly.

In the current example, the substrate 120 includes a ground plane 121, 124 on each side, as shown in FIGS. 1D and 1E respectively. In this example, the coupling paths 131, 132 are defined by a cut-out 133 in the ground plane 121, so that the coupling paths 131, 132 are connected to the ground plane 121 at one end, although this is not essential and alternatively other arrangements may be used. For example, the couplings do not need to be coupled to a ground plane, and alternatively open ended couplings could be used. A further alternative is that a ground plane may not be provided, in which case the coupling paths 131, 132 could be formed from conductive tracks applied to the substrate 120. In this instance, the couplings 131, 132 can still be electrically coupled to ground, for example via vias or other connections provided on the substrate.

The input and output are provided in the form of conductive paths 141, 142 provided on an underside of the substrate 120, and these are typically defined by cut-outs 125, 126 in the ground plane 124. The input and output may in turn be coupled to additional connections depending on the intended application. For example, the input and output paths 141, 142 could be connected to edge-mount SMA coaxial connectors, direct coaxial cable connections, surface mount coaxial connections, chassis mounted coaxial connectors, or solder pads to allow the filter 100 to be directly soldered to another PCB, with the method chosen depending on the intended application. Alternatively the filter could be integrated into the PCB of other components of a communications system.

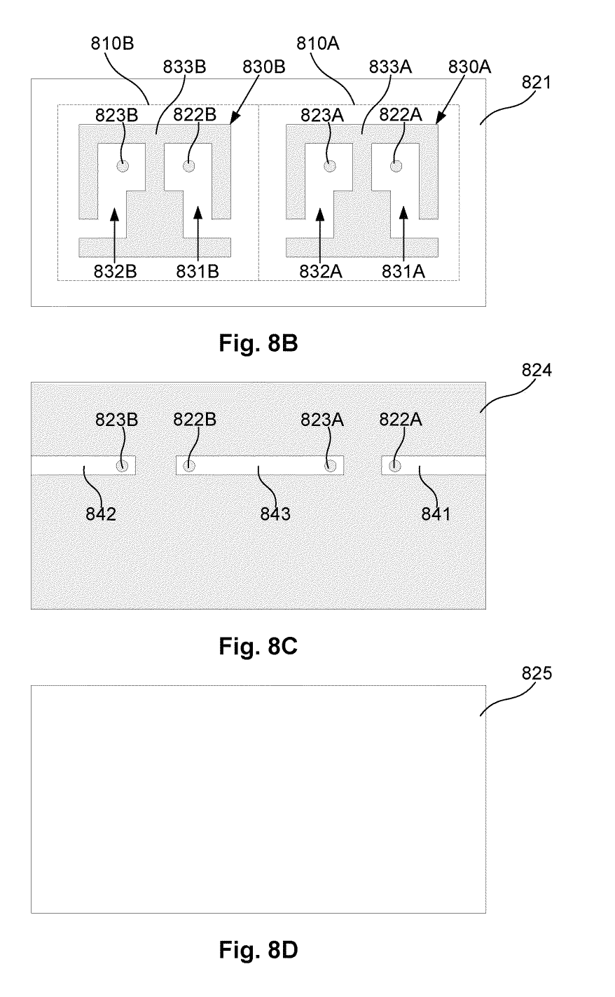

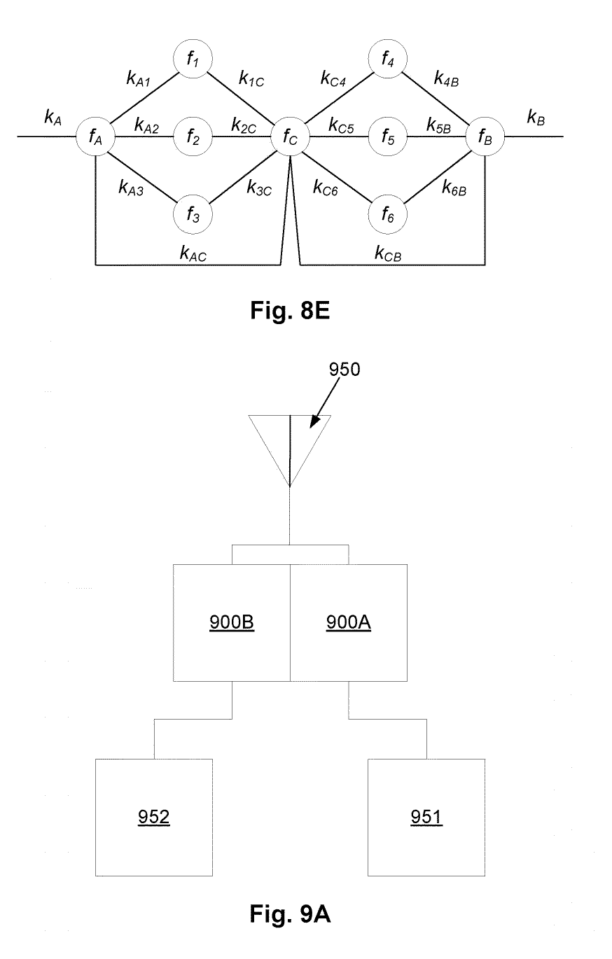

In the above example, the input and output paths 141, 142 are provided on an underside of the substrate. However, in this instance, the input and output paths 141, 142 are not enclosed by a ground plane. Accordingly, in an alternative example, a three layered PCB can be used, with the input and output paths embedded as transmission lines inside the PCB, with the top and underside surfaces providing a continuous ground plane, as will be described in more detail below, with respect to the example of FIGS. 8A to 8E. This has the virtue of providing full shielding of the inner parts of the filter, and also allows the filter to be mounted to a conducting or non-conducting surface, as convenient.

The input and output paths 141, 142 can be coupled to the couplings 131, 132 using any suitable technique, such as capacitive or inductive coupling, although in this example, this is achieved using respective electrical connections 122, 123, such as connecting vias, extending through the substrate 120. In this example, the input and output paths 141, 142 are electrically coupled to first ends of the coupling paths, with second ends of the coupling paths being electrically connected to ground.

In use, resonance modes of the resonator body provide respective energy paths between the input and output. Furthermore, the input coupling and the output coupling can be configured to allow coupling therebetween to provide an energy path separate to energy paths provided by the resonance modes of the resonator body. This can provide four parallel energy paths between the input and the output. These energy paths can be arranged to introduce at least one transmission zero to the frequency response of the filter, as will be described in more detail below. In this regard, the term “zero” refers to a transmission minimum in the frequency response of the filter, meaning transmission of signals at that frequency will be minimal, as will be understood by persons skilled in the art.

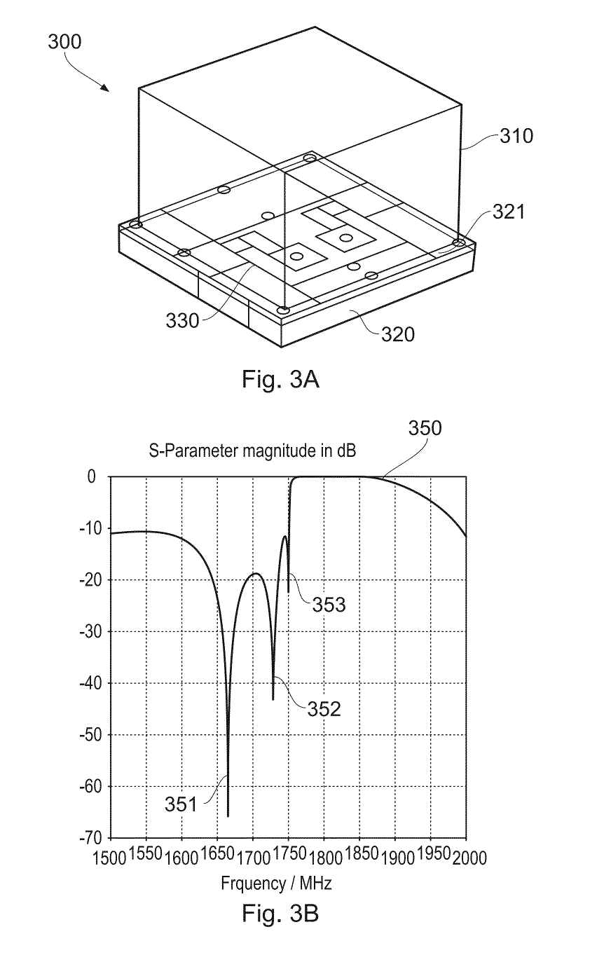

A specific example filter is shown in FIG. 3A. In this example, the filter 300 includes a resonator body 310 made of 18 mm cubic ceramic body that has been silver coated on 5 sides, with the sixth side silvered in a thin band around the perimeter. The sixth side is soldered to a ground plane 321 on an upper side of a PCB 320, so that the coupling structure 330 is positioned against the un-silvered surface of the resonator body 310. Input and output lines on the PCB are implemented as coplanar transmission lines on an underside of the PCB 320 (not shown). It will therefore be appreciated that this arrangement is generally similar to that described above with respect to FIGS. 1A to 1E.

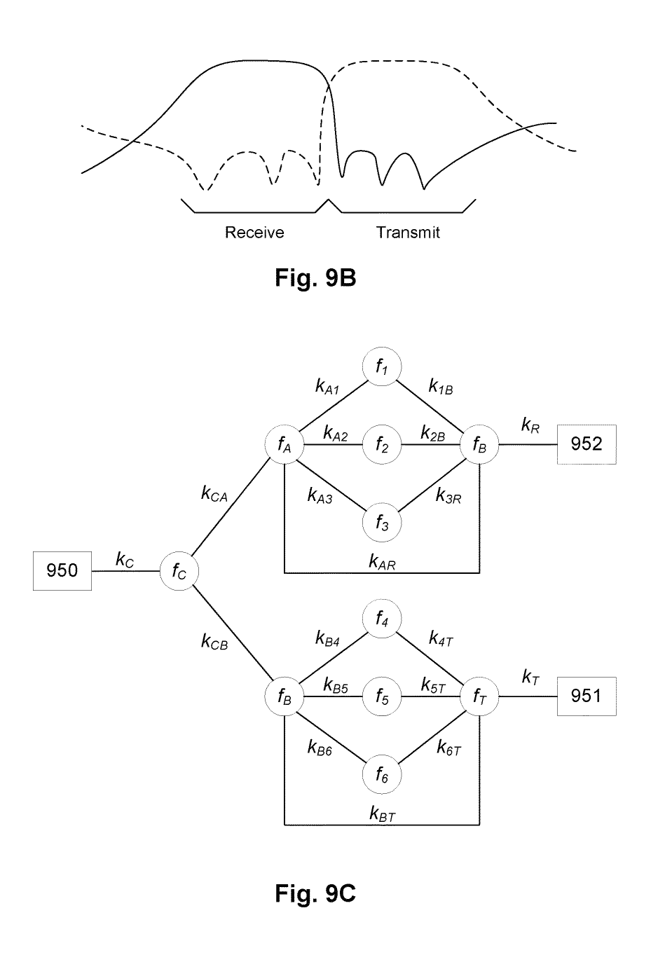

An example of a calculated frequency response for the filter is shown in FIG. 3B. As shown, the filter 100 can provide three low side zeros 351, 352, 353 adjacent to a sharp transition to a high frequency pass band 350. Alternatively, the filter 100 can provide three high side zeros adjacent to a sharp transition to a lower frequency pass band, described in more detail below with respect to FIG. 9B. When two filters are used in conjunction for transmission and reception, this allows transmit and receive frequencies to be filtered and thereby distinguished, as will be understood by persons skilled in the art.

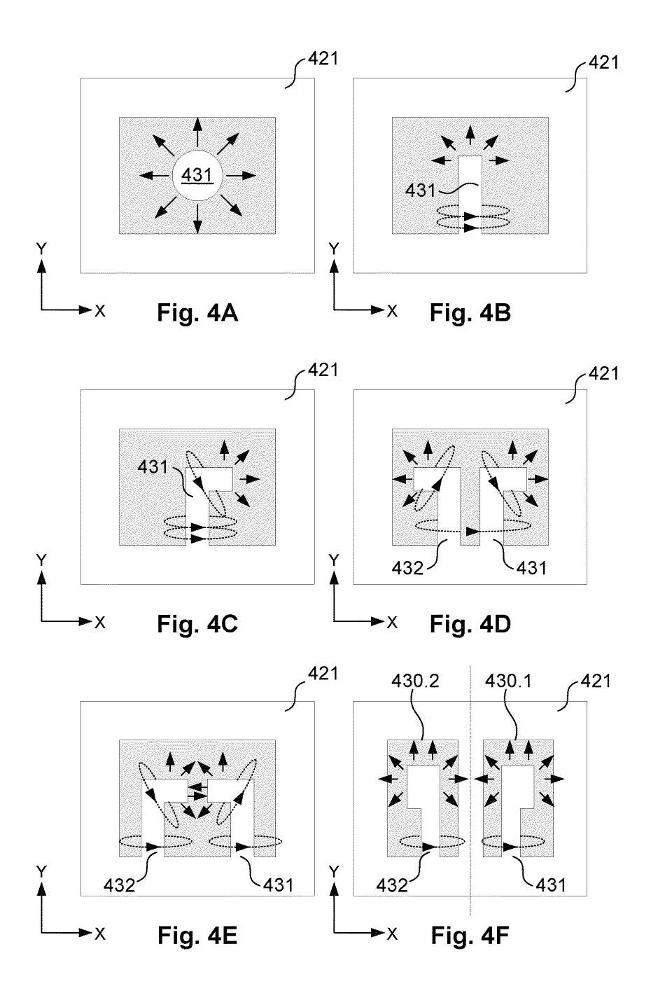

Example coupling structures will now be described with reference to FIGS. 4A to 4F, together with an explanation of their ability to couple to different modes of a cubic resonator, thereby assisting in understanding the operation of the filter.

Traditional arrangements of coupling structures include a probe extending into the resonator body, as described for example in U.S. Pat. No. 6,853,271. In such arrangements, most of the coupling is capacitive, with some inductive coupling also present due to the changing currents flowing along the probe. If the probe is short, this effect will be small. Whilst such a probe can provide reasonably strong coupling, this tends to be with a single mode only, unless the shape of the coupling structure is modified. For a cubic resonator body, the coupling for each of the modes is typically as shown in Table 1 below.

TABLE 1

| Mode | H field coupling | E field coupling | Notes |
|---|---|---|---|
| TE 011 | Negligible or zero due | Negligible or zero | Negligible |
| (E along X) | to tiny and orthogonal | due to symmetry. | coupling |
| | field. | | |
| TE 101 | Negligible or zero due | Negligible or zero | Negligible |
| (E along Y) | to tiny and orthogonal | due to symmetry. | coupling |
| | field. | | |
| TM 110 | Some for long probe | strong | Strong |
| (E along Z) | | | coupling |

Furthermore, a probe has the disadvantage of requiring a hole to be bored into the cube.

An easier to manufacture (and hence cheaper) alternative is to use a surface patch, as shown for example in FIG. 4A, in which a ground plane 421 is provided together with a coupling 431. In this example, an electric field extending into the resonator body is generated by the patch, as shown by the arrows. The modes of coupling are as summarised in Table 2, and in general this succeeds in only weakly coupling with a single mode. Despite this, coupling into a single mode only can prove useful, for example if multiple couplings are to be provided on different surfaces to each couple only to a single respective mode. This could be used, for example, to allow multiple inputs and or outputs to be provided.

TABLE 2

| | H field | | |
|---|---|---|---|
| Mode | coupling | E field coupling | Notes |
| TE 011 | none | Negligible or zero due to | Negligible coupling |
| (E along X) | | symmetry | |
| TE 101 | none | Negligible or zero due to | Negligible coupling |
| (E along Y) | | symmetry | |
| TM 110 | none | Medium | Medium coupling |
| (E along Z) | | | |

Coupling into two modes can be achieved using a quarter wave resonator, which includes a path extending along a surface of the coupling 431, as shown for example in FIG. 4B. The electric and magnetic fields generated upon application of a signal to the coupling are shown in solid and dotted lines respectively.

In this example, the coupling 431 can achieve strong coupling due to the fact that a current antinode at the grounded end of the coupling produces a strong magnetic field, which can be aligned to match those of at least two resonance modes of the resonator body. There is also a strong voltage antinode at the open circuited end of the coupling, and this produces a strong electric field which couples to the TM110 mode, as summarised below in Table 3.

TABLE 3

| | H field | E field | |
|---|---|---|---|
| Mode | coupling | coupling | Notes |
| TE 011 (E along X) | Weak or | Weak or zero | Negligible coupling |
| | zero | | |
| TE 101 (E along Y) | strong | Weak or zero | Strong coupling |
| TM 110 (E along Z) | strong | medium | Strongest coupling |

In the example of FIG. 4C, the coupling 431 includes an angled path, meaning a magnetic field is generated at different angles. However, in this arrangement, coupling to both of the TE modes as well as the TM mode still does not occur as eigenmodes of the combined system of resonator cube and input coupling rearrange to minimise the coupling to one of the three eigenmodes.

To overcome this, a second coupling 432 can be introduced in addition to the first coupling 431, as shown for example in FIG. 4D. This arrangement avoids minimisation of the coupling and therefore provides strong coupling to each of the three resonance modes. The arrangement not only provides coupling to all three resonance modes for both input and output couplings, but also allows the coupling strengths to be controlled, and provides further input to output coupling.

In this regard, the coupling between the input and output couplings 431, 432 will be partially magnetic and partially electric. These two contributions are opposed in phase, so by altering the relative amounts of magnetic and electric coupling it is possible to vary not just the strength of the coupling but also its polarity.

Thus, in the example of FIG. 4D, the grounded ends of the couplings 431, 432 are close whilst the coupling tips are distant. Consequently, the coupling will be mainly magnetic and hence positive, so that a filter response including zeros at a higher frequency than a pass band is implemented, as will be described in more detail below with respect to the receive band in FIG. 9B. In contrast, if the tips of the couplings 431, 432 are close and the grounded ends distant, as shown in FIG. 4E, the coupling will be predominantly electric, which will be negative, thereby allowing a filter with zeros at a lower frequency to a pass band to be implemented, similar to that shown at 350, 351, 352, 353 in FIG. 3B.

In the example of FIG. 4F, two coupling structures 430.1, 430.2 are provided on a ground plane 421, each coupling structure defining 430.1, 430.2 a respective coupling 431, 432. The couplings are similar to those described above and will not therefore be described in further detail. The provision of multiple coupling structures allows a large variety of arrangements to be provided. For example, the coupling structures can be provided on different surfaces, of the resonator body, as shown by the dotted line. This could be performed by using a shaped substrate, or by providing separate substrates for each coupling structure. This also allows for multiple inputs and/or outputs to be provided.

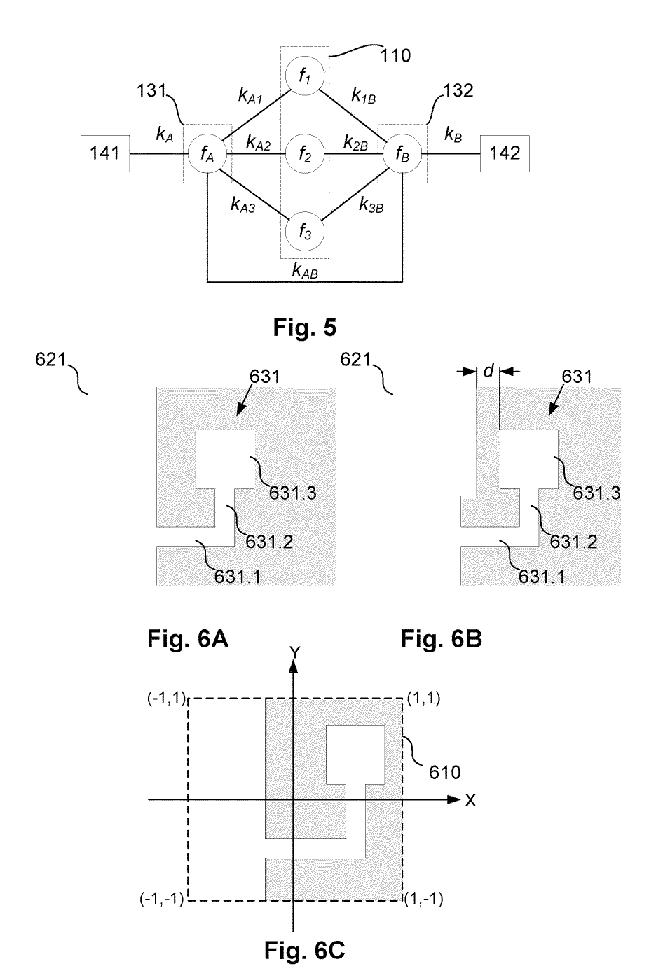

In practice, the filter described in FIGS. 1A to 1E can be modelled as two low Q resonators, representing the input and output couplings 131, 132 coupled to three high Q resonators, representing the resonance modes of the resonator body 110, and with the two low Q resonators also being coupled to each other. An example filter network model is shown in FIG. 5.

In this example, the input and output couplings 131, 132 have respective resonant frequencies f_{A}, f_{B}, whilst the resonance modes of the resonator body 110 have respective resonant frequencies f₁, f₂, f₃. The degree of coupling between an input 141 and output 142 and the respective input and output couplings 131, 132 is represented by the coupling constants k_{A}, k_{B}. The coupling between the couplings 131, 132 and the resonance modes of the resonator body 110 are represented by the coupling constants k_{A1}, k_{A2}, k_{A3}, and k_{1B}, k_{2B}, k_{3B}, respectively, whilst coupling between the input and output couplings 131, 132 is given by the coupling constant k_{AB}.

It will therefore be appreciated that the filtering response of the filter can be controlled by controlling the coupling constants and resonance frequencies of the couplings 131, 132 and the resonator body 110.

In one example, a desired frequency response is obtained by configuring the resonator body 110 so that f₁<f₂<f₃ and the couplings 131, 132 so that f₁<f_{A}, f_{B}<f₃. This places the first resonator f₁ close to the desired sharp transition at the band edge, as shown for example at 353, 363 in FIG. 3B. The coupling constants k_{A1}, k_{A3}, k_{1B}, k_{2B}, k_{3B}, are selected to be positive, whilst the constant k_{A2} is negative. If the zeros are to be on the low frequency side of the pass band, as shown for example at 351, 352, 353 and as will be described in more detail below with respect to the transmit band in FIG. 9B, the coupling constant k_{AB} should be negative, while if the zeros are to be on the high frequency side as will be described in more detail below with respect to the receive band in FIG. 9B, the coupling constant k_{AB} should be positive. The coupling constants k_{AB}, k_{A1} generally have similar magnitudes, although this is not essential, for example if a different frequency response is desired.

The strength of the coupling constants can be adjusted by varying the shape and position of the input and output couplings 131, 132, as will now be described in more detail with reference to FIGS. 6A to 6C.

For the purpose of this example, a single coupling 631 is shown coupled to a ground plane 621. The coupling 631 is of a similar form to the coupling 131 and therefore includes a first path 631.1 extending perpendicularly away from the ground plane 621, a second path 631.2 extending in a direction orthogonal to the first path 631.1 and terminating in a conductive coupling patch 631.3. In use, the first and second paths 631.1, 631.2 are typically arranged parallel to the axes of the resonator body, as shown by the axes X, Y, with the coordinates of FIG. 6C representing the locations of the coupling paths relative to a resonator body shown by the dotted lines 610, extending from (−1,−1) to (1,1). This is for the purpose of example only, and is not intended to correspond to the positioning of the resonator body in the examples outlined above. To highlight the impact of the configuration of the coupling 631 on the degrees of coupling reference is also made to the distance d shown in FIG. 6B, which represents the proximity of patch 631.3 to the ground plane 621.

In this example, the first path 631.1 is provided adjacent to the grounded end of the coupling 631 and therefore predominantly generates a magnetic field as it is near a current anti-node. The second path 631.2 has a lower current and some voltage and so will generate both magnetic and electric fields. Finally the patch 631.3 is provided at an open end of the coupling and therefore predominantly generates an electric field since it is near the voltage anti-node.

In use, coupling between the coupling 631 and the resonator body can be controlled by varying coupling parameters, such as the lengths and widths of the coupling paths 631.1, 631.2, the area of the coupling patch 631.3, as well as the distance d between the coupling patch 631.3 and the ground plane 621. In this regard, as the distance d decreases, the electric field is concentrated near the perimeter of the resonator body, rather than up into the bulk of the resonator body, so this decreases the electric coupling to the resonance modes.

Referring to the field directions of the three cavity modes shown in FIGS. 2A to 2C, the effect of varying the coupling parameters is as summarised in Table 4 below. It will also be appreciated however that varying the coupling path width and length will affect the impedance of the path and hence the frequency response of the coupling path 631. Accordingly, these effects are general trends which act as a guide during the design process, and in practice multiple changes in coupling frequencies and the degree of coupling occur for each change in coupling structure and resonator body geometry. Consequently, when designing a coupling structure geometry it is typical to perform simulations of the 3D structure to optimise the design.

TABLE 4

| Mode | Coupling Strength to Quarter Wave Resonator |
|---|---|
| TE 011 (E along X) | Maximum coupling when the first path 631.1 |
| | is long and at y = 0. |
| | Negligible coupling from the second path 631.2. |
| | Negligible coupling from the patch 631.3 when |
| | positioned at x = 0, y = 0. |
| TE 101 (E along Y) | Negligible coupling from the first path 631.1. |
| | Maximum coupling when the second path |
| | 631.2 is long and at x = 0. |
| | Negligible coupling from the patch 631.3 when |
| | positioned at x = 0, y = 0. |
| TM 110 (E along Z) | Maximum coupling when the first path |
| | 631.1 is long and at x = −1, y = 0. |
| | Maximum coupling when the second path 631.2 is |
| | long and at x = 0, y = +1 or −1. |
| | Maximum coupling when the patch 631.3 is large |
| | and at x = 0, y = 0. |
| | Decreased coupling when the distance d is small. |

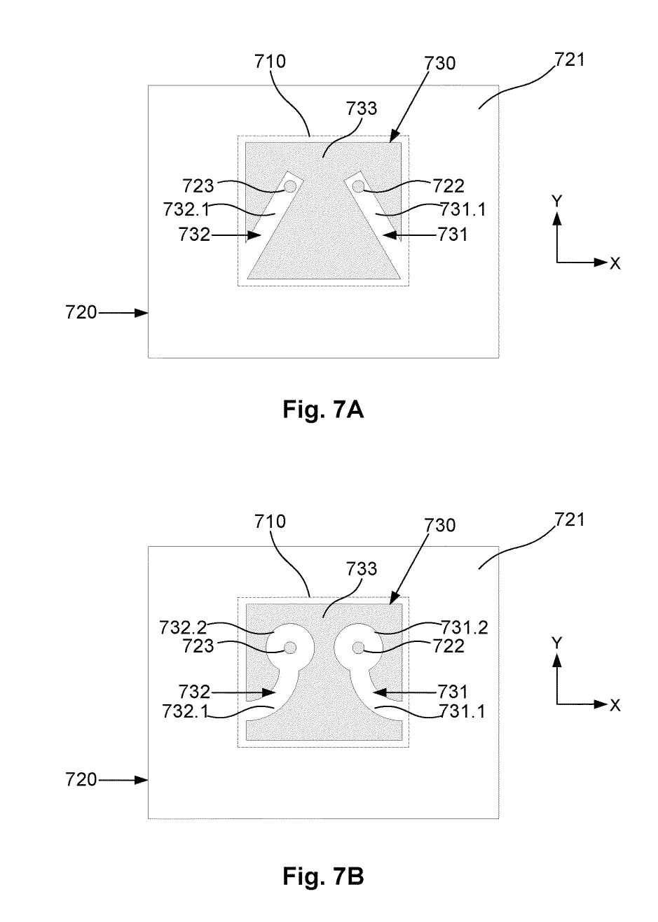

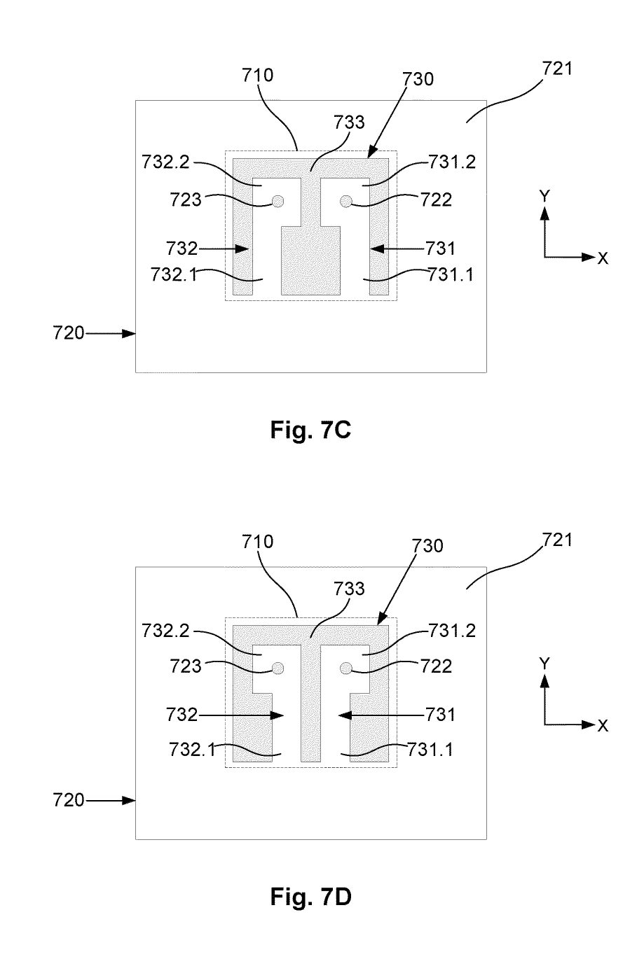

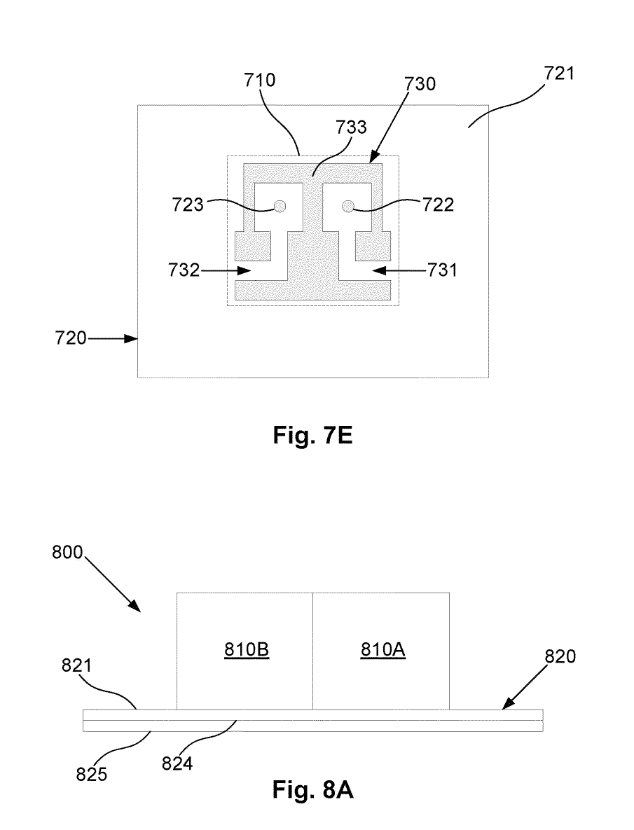

It will be appreciated from the above that a range of different coupling structure configurations can be used, and examples of these are shown in FIGS. 7A to 7E. In these examples, reference numerals similar to those used in FIG. 1D are used to denote similar features, albeit increased by 600.

Thus, in each example, the arrangement includes a resonator body 710 mounted on a substrate 720, having a ground plane 721. A coupling structure 730 is provided by a cut-out 733 in the ground plane 721, with the coupling structure including two couplings 731, 732, representing input and output couplings respectively. In this example, vias 722, 723 act as connections to an input and output respectively (not shown in these examples).

In the example of FIG. 7A, the input and output couplings 731, 732 include a single straight coupling path 731.1, 732.1 extending from the ground plane 721 at an angle relative to the X, Y axes. This generates a magnetic field at the end of the path near the ground plane, with this providing coupling to each of the TE fields.

In the example of FIG. 7B, the input and output couplings 731, 732 include a single curved coupling path 731.1, 732.1 extending from the ground plane 721, to a respective coupling patch 731.2, 732.2. As shown the path extends a distance along each of the X, Y axes, so that magnetic fields generated along the path couple to each of the TE and TM modes, whilst the patch predominantly couples to the TM mode. It will be noted that in this example the patch 731.2, 732.3 has a generally circular shape, highlighting that different shapes of patch can be used.

In the examples of FIGS. 7C and 7D, the input and output couplings 731, 732 include a single coupling path 731.1, 732.1 extending from the ground plane 721 to a patch 731.2, 732.2, in a direction parallel to an X-axis. The paths 731.1, 732.1 generate a magnetic field that couples to the TE101 and TM modes, whilst the patch predominantly couples to the TM mode.

In the example of FIG. 7D the grounded ends of the couplings 731.1, 732.1 are close whilst the coupling tips are distant. Consequently, the coupling will be mainly magnetic and so the coupling will be positive, thereby allowing a filter having high frequency zeros to be implemented. In contrast, if the tips of the couplings 731.1, 732.1 are close and the grounded ends distant, as shown in FIG. 7C, the coupling will be predominantly electric, which will be negative and thereby allow a filter with low frequency zeros to be implemented.

In the arrangement of FIG. 7E, this shows a modified version of the coupling structure of FIG. 1D, in which the cut-out 733 is modified so that the patch 731.3, 732.3 is nearer the ground plane, thereby decreasing coupling to the TM field, as discussed above.

In some scenarios, a single resonator body cannot provide adequate performance (for example, attenuation of out of band signals). In this instance, filter performance can be improved by providing two or more resonator bodies arranged in series, to thereby implement a higher-performance filter.

In one example, this can be achieved by providing two resonator bodies in contact with each other, with one or more apertures provided in the silver coatings of the resonator bodies, where the bodies are in contact. This allows the fields in each cube to enter the adjacent cube, so that a resonator body can receive a signal from or provide a signal to another resonator body. When two resonator bodies are connected, this allows each resonator body to include only a single coupling, with a coupling on one resonator body acting as an input and the coupling on the other resonator body acting as an output. Alternatively, the input of a downstream filter can be coupled to the output of an upstream filter using a suitable connection such as a short transmission line. An example of such an arrangement will now be described with reference to FIGS. 8A to 8E.

In this example, the filter includes first and second resonator bodies 810A, 810B mounted on a common substrate 820. The substrate 820 is a multi-layer substrate providing external surfaces 821, 825 defining a common ground plane, and an internal surface 824.

In this example, each resonator body 810A, 810B is associated with a respective coupling structure 830A, 830B provided by a corresponding cut-out 833A, 833B in the ground plane 821. The coupling structures 830A, 830B include respective input and output couplings 831A, 832A, 831B, 832B, which are similar in form to those described above with respect to FIG. 1D, and will not therefore be described in any detail. Connections 822A, 823A, 822B, 823B couple the couplings 831A, 832A, 831B, 832B to paths on the internal layer 824. In this regard, an input 841 is coupled via the connection 822A to the coupling 831A. A connecting path 843 interconnects the couplings 832A, 831B, via connections 823A, 822B, with the coupling 823B being coupled to an output 842, via connection 823B.

It will therefore be appreciated that in this example, signals supplied via the input 841 are filtered by the first and second resonator bodies 810A, 810B, before in turn being supplied to the output 842.

In this arrangement, the connecting path 843 acts like a resonator, which distorts the response of the filters so that the cascade response cannot be predicted by simply multiplying the responses of the two cascaded filters. Instead, the resonance in the transmission line must be explicitly included in a model of the whole two cube filter. For example, the transmission line could be modelled as a single low Q resonator having frequency f_{C}, as shown in FIG. 8E.

A common application for filtering devices is to connect a transmitter and a receiver to a common antenna, and an example of this will now be described with reference to FIG. 9A. In this example, a transmitter 951 is coupled via a filter 900A to the antenna 950, which is further connected via a second filter 900B to a receiver 952.

In use, the arrangement allows transmit power to pass from the transmitter 951 to the antenna with minimal loss and to prevent the power from passing to the receiver. Additionally, the received signal passes from the antenna to the receiver with minimal loss.

An example of the frequency response of the filter is as shown in FIG. 9B. In this example, the receive band (solid line) is at lower frequencies, with zeros adjacent the receive band on the high frequency side, whilst the transmit band (dotted line) is on the high frequency side, with zeros on the lower frequency side, to provide a high attenuation region coincident with the receive band. It will be appreciated from this that minimal signal will be passed between bands. It will be appreciated that other arrangements could be used, such as to have a receive pass band at a higher frequency than the transmit pass band.

The duplexed filter can be modelled in a similar way to the single cube and cascaded filters, with an example model for a duplexer using single resonator body transmit and receive filters being shown in FIG. 9C. In this example, the transmit and receive filters 900A, 900B are coupled to the antenna via respective transmission lines, which in turn provide additional coupling represented by a further resonator having a frequency f_{C}, and coupling constants k_{C}, k_{CA}, k_{CB}, determined by the properties of the transmission lines.

It will be appreciated that the filters 900A, 900B can be implemented in any suitable manner. In one example, each filter 900 includes two resonator bodies provided in series, with the four resonator bodies mounted on a common substrate, as will now be described with reference to FIGS. 10A to 10C.

In this example, multiple resonator bodies 1010A, 1010B, 1010C, 1010D can be provided on a common multi-layer substrate 1020, thereby providing transmit filter 900A formed from the resonator bodies 1010A, 1010B and a receive filter 900B formed from the resonator bodies 1010C, 1010D.

As in previous examples, each resonator body 1010A, 1010B, 1010C, 1010D is associated with a respective coupling structure 1030A, 1030B, 1030C, 1030D provided by a corresponding cut-out 1033A, 1033B, 1033C, 1033D in a ground plane 1021. Each coupling structure 1030A, 1030B, 1030C, 1030D includes respective input and output couplings 1031A, 1032A, 1031B, 1032B, 1031C, 1032C, 1031D, 1032D, which are similar in form to those described above with respect to FIG. 1D, and will not therefore be described in any detail. However, it will be noted that the coupling structures 1030A, 1030B, for the transmitter 951 are different to the coupling structures 1030C, 1030D for the receiver 952, thereby ensuring that different filtering characteristic are provided for the transmit and receive channels, as described for example with respect to FIG. 9B.

Connections 1022A, 1023A, 1022B, 1023B, 1022C, 1023C, 1022D, 1023D couple the couplings 1031A, 1032A, 1031B, 1032B, 1031C, 1032C, 1031D, 1032D, to paths on an internal layer 1024 of the substrate 1020. In this regard, an input 1041 is coupled via the connection 1022A to the coupling 1031A. A connecting path 1043 couples the couplings 1032A, 1031B, via connections 1023A, 1022B, with the coupling 1023B being coupled to an output 1042, and hence the antenna 950, via a connection 1023B. Similarly an input 1044 from the antenna 950 is coupled via the connection 1022C to the input coupling 1031C. A connecting path 1045 couples the couplings 1032C, 1031D, via connections 1023C, 1022D, with the coupling 1022D being coupled to an output 1046, and hence the receiver 952, via a connection 1023D.

Accordingly, the above described arrangement provides a cascaded duplex filter arrangement. The lengths of the transmission lines can be chosen such that the input of each appears like an open circuit at the centre frequency of the other. To achieve this, the filters are arranged to appear like 50 ohm loads in their pass bands and open or short circuits outside their pass bands.

It will be appreciated however that alternative arrangements can be employed, such as connecting the antenna to a common coupling, and then coupling this to both the receive and transmit filters. This common coupling performs a similar function to the transmission line junction above.

Accordingly, the above described filter arrangements use a multimode filter described by a parallel connection, at least within one body. The natural oscillation modes in an isolated body are identical with the global eigenmodes of that body. When the body is incorporated into a filter, a parallel description of the filter is the most useful one, rather than trying to describe it as a cascade of separate resonators.

The filters can not only be described as a parallel connection, but also designed and implemented as parallel filters from the outset. The coupling structures on the substrate are arranged so as to controllably couple with prescribed strengths to all of the modes in the resonator body, with there being sufficient degrees of freedom in the shapes and arrangement of the coupling structures and in the exact size and shape of the resonator body to provide the coupling strengths to the modes needed to implement the filter design. There is no need to introduce defects into the body shape to couple from mode to mode. All of the coupling is done via the coupling structures, which are typically mounted on a substrate such as a PCB. This allows us to use a very simple body shape without cuts of bevels or probe holes or any other complicated and expensive departures from easily manufactured shapes.

The above described examples have focused on coupling to up to three modes. It will be appreciated this allows coupling to be to low order resonance modes of the resonator body. However, this is not essential, and additionally or alternatively coupling could be to higher order resonance modes of the resonator body.

The above examples include coupling structures including conductive coupling paths. It will be appreciated that, in practice, the degree of coupling between such a path (or an element of one) and its associated resonator body will vary as a function of the frequency of the electrical signal that is conveyed by the path (or the element) and that there will be a resonant peak in the degree of coupling at some frequency that is dependent on the shape and dimensions of the path (or the element). If such a path (or element) is arranged to convey an electrical signal at that resonant frequency, then it is reasonable to term the path (or element) a “resonator”. Indeed, the path 431 in FIG. 4B is referred to a quarter wave resonator, the resonant frequency being determined by the length of the path 431.

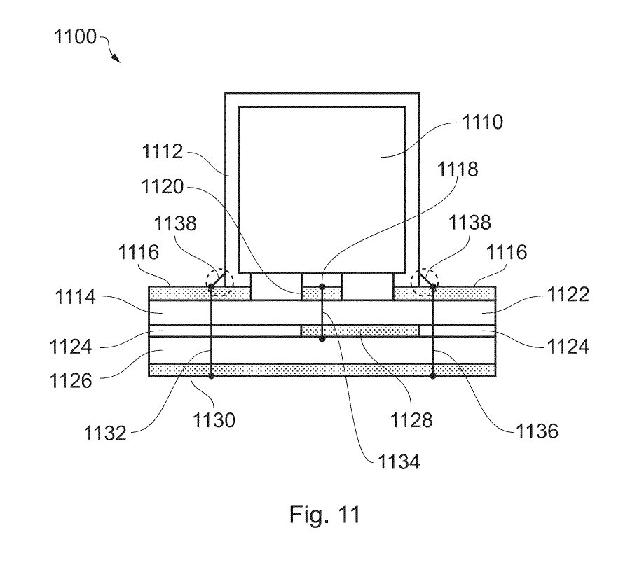

FIG. 11 shows a cross section through a multi-mode cavity filter 1100 according to an embodiment of the invention. The resonant cavity of the filter is provided by a cubic body 1110 of a ceramic dielectric material, with a conductive (e.g. metal) coating 1112. The body 1110 is mounted on a printed circuit board (PCB) 1114. The coating 1112 has a square window on the side of the body 1110 that contacts the PCB 1114 and the window is aligned with an identical window in a conductive (e.g. metal) ground plane 1116 on top of the PCB 1114. In these respects, the filter 1100 is the same as the filters described earlier in this document, e.g. the filter shown in FIGS. 1A to 1E and the filter shown in FIG. 3A.

Like the filters described earlier in this document, filter 1100 has coupling tracks for coupling a signal into the body 1110 and for coupling the signal out of the body 1110 as part of the process of filtering the signal. These coupling tracks can be in any of the previously described configurations, for example as shown in 1D, 4A to 4F and 6A to 7E. In filter 1100, however, and in accordance with an option mentioned earlier, the coupling tracks are not provided on the PCB 1114 but are instead provided on the body 1110. One of these coupling tracks appears in the cross section of FIG. 11 and is indicated 1118. The coupling tracks exchange signals with the PCB 1114 by means of connection tracks that are provided on the PCB 1114 in the window of the ground plane 1116. One of these connection tracks appears in the cross section of FIG. 11 and is indicated 1120.

FIG. 11 shows some details of the construction of the PCB 1114. The PCB 1114 has a laminated structure. The ground plane 1116 and the connection tracks are provided on a stratum 1122 of non-conductive material that is a low loss dielectric material, albeit one with typically (but not necessarily) a much lower relative permittivity than the ceramic of the body 1110. Stratum 1122 is bonded by glue 1124, to a further stratum 1126 of the same non-conductive material. Sandwiched between the two strata 1122 and 1126 are input and output tracks for coupling signals into and out of the body 1110 so that filtering can take place. One of these input and output tracks appears in the cross section of FIG. 11 and is indicated 1128. The lower side of stratum 1126 is coated with a conductive (e.g. metal) ground plane 1130. By surrounding the input and output tracks with ground planes 1116 and 1130, the signals that travel in the input and output tracks are shielded from electrical interference external to the filter 1100.

The filter 1100 is provided with vias 1132, 1134 and 1136 to electrically connect various elements of the filter. Vias, as is well known in the field of circuit design, are bores containing conductive material, normally in the form of a metal lining, in order to electrically interconnect elements located at the ends of, or along the length of, the bore. Here, vias 1132 and 1136 connect the two ground planes 1116 and 1130 to ensure that they stay at the same electric potential. Via 1134 connects the one of the input and output tracks that is indicated 1128 with the connection track 1120 so that signals to be filtered can be transferred between track 1128 and the body 1110.

It will be appreciated that FIG. 11 is schematic, at least to the extent that, in practice, it is unlikely that all of the features shown would appear in the same cross section through the filter 1100.

The body 1110 is fixed to the PCB 1114 by, for example, soldering the overlapping parts of the coating 1112 and the ground plane 1116. Shoulders 1138 of solder are provided to connect the vertical walls of the covering 1112 to the ground plane 1116, thus enhancing the mechanical strength of the filter 1100. The covering 1112 is maintained at the same ground potential as the ground planes 1116 and 1130 by virtue of being electrically connected to the ground plane 1116. The ground plane 1130 obscures the window in ground plane 1116 thus supplying the otherwise absent side of the grounded, dielectric-filled resonator cavity that the coating 1112 is intended to provide.

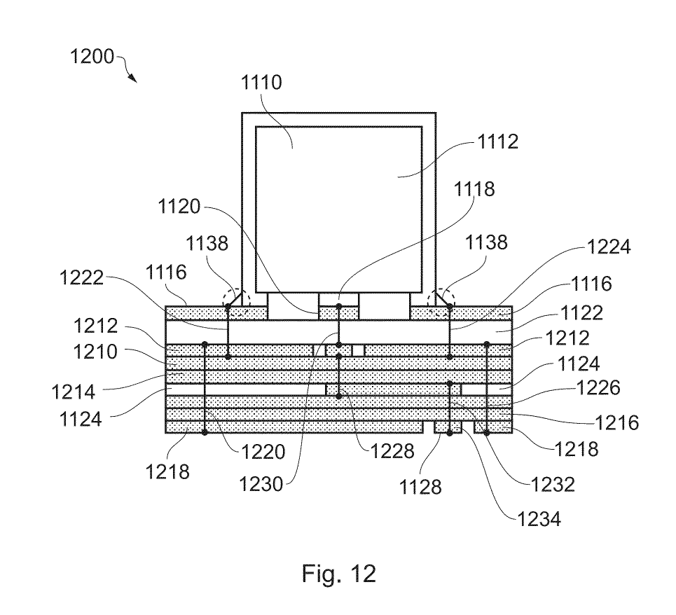

The filter 1100 is constructed onto the PCB 1114, and the PCB 1114 may also carry other circuitry too, for example circuitry for conditioning, e.g. amplifying, signals prior to filtering them with filter 1100. FIG. 12 shows a variant of filter 1100, in which the PCB to which the filter is attached is designed to be incorporated with a PCB carrying other circuitry. FIG. 12 will now be discussed in detail.

FIG. 12 shows a filter 1200 that is a variant of filter 1100 of FIG. 11. Elements of FIG. 11 that have been carried over to FIG. 12 retain the same reference numerals and their nature and purpose will not be reiterated here. In summary, filter 1200 differs from filter 1100 in the nature of the PCB 1210 to which the conductively-coated ceramic body 1110 is connected. A ground plane 1212 is provided on the underside of non-conductive material stratum 1122, and it is this ground plane that obscures the window in ground plane 1116 thus supplying the otherwise absent side of the grounded, dielectric-filled resonator cavity that the coating 1112 is intended to provide.

A further stratum 1214 of the same material as stratum 1122 is provided under the ground plane 1212. Stratum 1214 is bonded by glue 1124, for example, to a yet further stratum 1216 of the same non-conductive material. Sandwiched between the two strata 1214 and 1216 are input and output tracks, one of which is again indicated 1128, for coupling signals into and out of the body 1110 so that filtering can take place. The lower side of stratum 1216 is coated with a conductive ground plane 1218. By surrounding the input and output tracks with ground planes 1212 and 1218, the signals that travel in the input and output tracks are shielded from electrical interference external to the filter 1200.

Vias 1220, 1222, 1224 and 1226 connect the ground planes 1116, 1212 and 1218 and the conductive coating 1112 together so that they are kept at the same ground potential. Via 1228 connects the track 1128 with the one of the connection tracks that is indicated 1120. The via 1228 is routed through an island 1230 that is formed in the ground plane 1212 and which is electrically isolated from the remainder of the ground plane 1212. The one of the input and output tracks that is indicated 1128 is also connected by a further via 1230 to an electrically isolated island 1232 in the ground plane 1218. The island 1232 serves as a connection pad by which the PCB 1210 can be connected to a further PCB (not shown) in order to filter signals supplied by that further PCB.

It will be appreciated that FIG. 12 is also schematic, at least to the extent that, in practice, it is unlikely that all of the features shown would appear in the same cross section through the filter 1200.

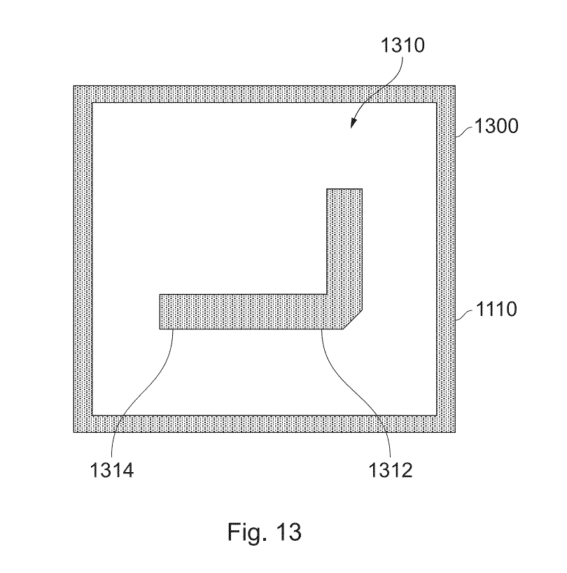

FIG. 13 shows an example of how the window in the coating 1112 might look. FIG. 13 shows the face of the cubic body 1110 on which the window is formed. In this example, the conductive coating 1112 extends onto that face, forming a relatively narrow, square frame 1300 around the peripheral part of the face and defining a relatively large, square window 1310 in the conductive coating 1112. In this example, the frame 1300 is made as narrow as possible in order to maximise the area of the window 1310, subject to the constraint that the frame 1300 must remain sufficiently wide to achieve a sufficiently reliable mechanical and electrical connection when the frame 1300 is soldered, for example, to the upper ground plane 1116. Also shown in FIG. 13 is an exemplary coupling track 1312, on which is schematically illustrated the location 1314 at which the coupling track 1312 will connect to the connection tracks 1120. Note that in some implementations of the filter, one of the ends of the coupling track could be connected to the frame of the window in the conductive coating surrounding the cubic body, thereby connecting that end of the track to the same ground potential as the conductive coating.

It is not essential that the window 1310 be square but the filter 1100 will have a better Q factor if the window has an aspect ratio that is not too unequal. For example, consider the longest vector that can be drawn across the window 1310 and the longest vector that can be drawn across the window in a direction orthogonal to the first vector. If the length of the second vector is at least 70% of the length of the first vector, then the aspect ratio should give the filter 1100 aQ factor which is very close to the highest possible Q-factor achievable with that particular filter configuration. The window 1310 also needs to be big enough to accommodate the coupling tracks, e.g. 1118. Generally, the window will be big enough for that if the length of the first vector mentioned above is at least 20% of the length of the shortest vector that extends completely across, and passes through the centroid of the shape of, the face of the body 1110 on which the window is located. The centroid of that shape is the point that would be the centre of gravity of a uniformly dense sheet having the shape of the outline of the face. Of course, if the shape is, for example, square, circular or is a regular polygon then the centroid is simply the shape's centre.

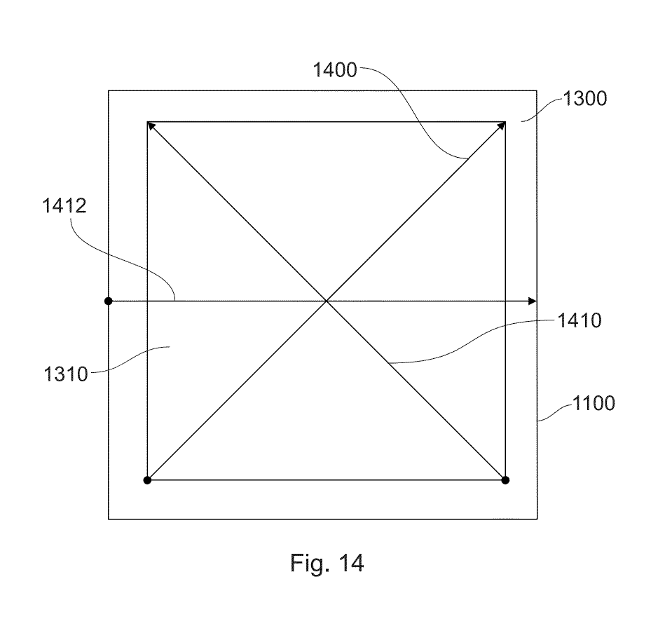

FIG. 14 reproduces the window 1310 of FIG. 13 without the coupling track 1312 and demonstrates that these criteria are met. Vector 1400 is the longest vector that can be drawn across the window 1310. Vector 1410 is the longest vector that can be drawn across the window in a direction orthogonal to vector 1400. The length of vector 1410 is more than 70% of the length of vector 1400. Vector 1412 is the shortest vector that can be drawn across the face through its centroid. Vector 1400 is more than 20% of the length of vector 1412. Therefore, the above mentioned criteria are met.

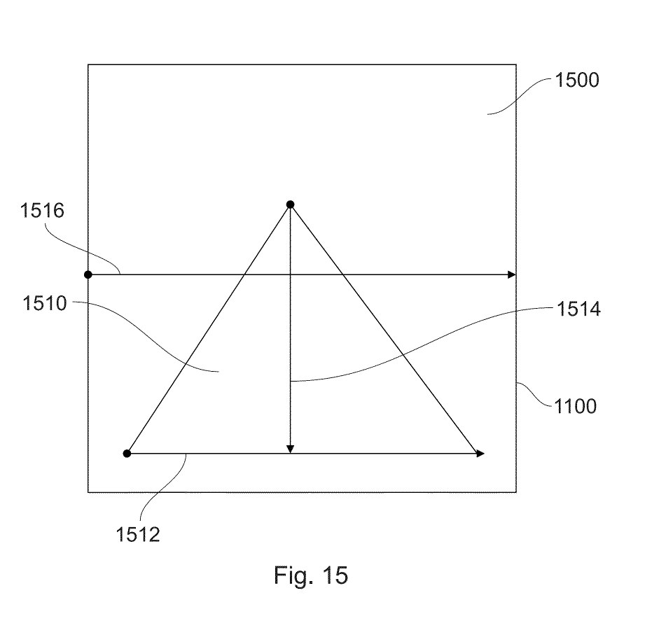

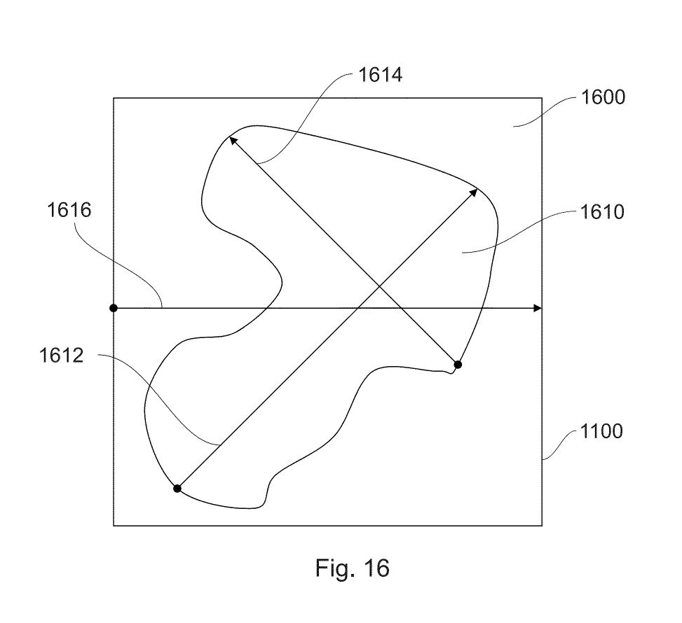

FIGS. 15 and 16 provide further examples of windows in the conductive coating 1112 that would meet also these criteria.

In FIG. 15, the conductive coating 1112 provides a frame 1500 defining a triangular window 1510 on the ceramic body 1110. Vector 1512 is the longest vector that can be drawn across the window 1510. Vector 1514 is the longest vector that can be drawn across the window in a direction orthogonal to vector 1512. The length of vector 1514 is more than 70% the length of vector 1512. Vector 1516 is the shortest vector that can be drawn across the face through its centroid. Vector 1512 is more than 20% of the length of vector 1516. Therefore, the above mentioned criteria are met.

In FIG. 16, the conductive coating 1112 provides a frame 1600 defining an irregularly shaped window 1610 on the ceramic body 1110. Vector 1612 is the longest vector that can be drawn across the window 1610. Vector 1614 is the longest vector that can be drawn across the window in a direction orthogonal to vector 1612. The length of vector 1614 is more than 70% the length of vector 1612. Vector 1616 is the shortest vector that can be drawn across the face through its centroid. Vector 1612 is more than 20% of the length of vector 1616. Therefore, the above mentioned criteria are met.

It will now be explained why the aspect ratio of the window is important for the Q factor. When the signal to be filtered is coupled into the ceramic body 1110, standing waves are established within the ceramic body and these standing waves induce currents in the conductive enclosure represented by the conductive coating 1112 and the ground plane that covers the window in the coating (e.g., ground planes 1130 and 1212 in FIGS. 11 and 12, respectively). As regards the wall of that conductive enclosure that is provided in part by the window frame and in part by the underlying ground plane, the induced current in that wall flows partly in the window frame and partly in the ground plane, so long as the window is not so small that current flow in the window becomes dominant and current flow in the groundplane relatively negligible. When the window has an unequal aspect ratio, then more of the induced current will be forced to flow in the frame around the window and less will flow in the underlying ground plane. With more current flowing in the frame, it is possible that the current will encounter choke points in the frame, which translate into increased resistance to the current, and that increased resistance in turn translates into increased losses and hence a reduced Q factor for the filter.

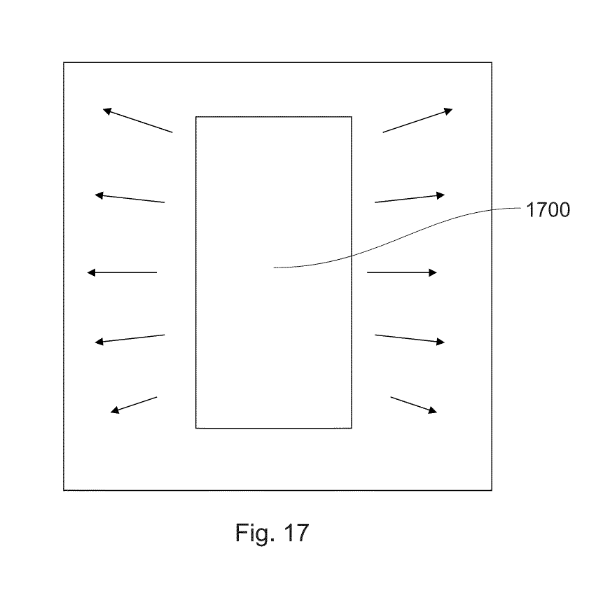

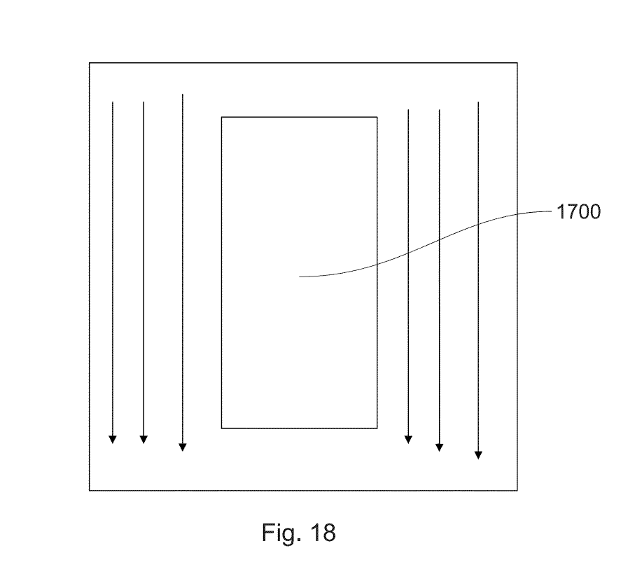

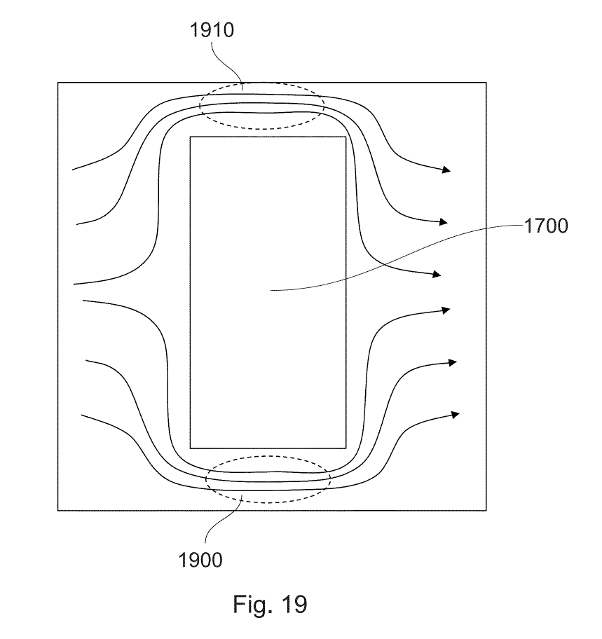

FIGS. 17 to 19 show the currents that flow in the frame of a window 1700 that does not meet the aforementioned 100:70 aspect ratio criterion. Each of FIGS. 17 to 19 shows the current flow, represented by arrows within the bounds of the window frame, for a different one of the three modes of standing waves that arise when the resonator body is cubic. It can be seen that for the modes shown in FIGS. 17 and 18, the current flow is relatively unimpeded, compared to FIG. 19 in which the current has to flow through narrow parts of the window frame 1900 and 1910, and there is relatively high resistance as a result, and hence a lowered Q factor.

Persons skilled in the art will appreciate that numerous variations and modifications will become apparent. All such variations and modifications which become apparent to persons skilled in the art, should be considered to fall within the spirit and scope that the invention broadly appearing before described.

We claim:

1. A multi-mode cavity filter, comprising:
a resonator body of dielectric material capable of supporting at least two degenerate electromagnetic standing wave modes and having a face; and
a conductive covering extending over all of the resonator body except a part of the face so that the covering defines an uncovered area on the face through which a signal can be at least one of: coupled into and coupled out of the body;
wherein:
there is a boundary between the uncovered area and the covering and bounding the uncovered area;
a first vector exists that is the longest vector that can be drawn between two points on the boundary without crossing any of the covering;
a second vector exists that extends in a direction orthogonal to the first vector and which is the largest vector that can be drawn in that direction between two points on the boundary without crossing any of the covering;
the covering is arranged so that the length of the second vector is at least 70% of the length of the first vector; and
the covering is arranged such that the length of the first vector is at least 20% of the length of the shortest vector that passes through the centroid of the face and extends completely across the face.

2. A multi-mode cavity filter according to claim 1, wherein the covering is arranged such that the uncovered area is symmetrical.

3. A multi-mode cavity filter according to claim 1, wherein the covering is arranged such that the uncovered area is one of triangular and square in shape.

4. A multi-mode cavity filter according to claim 1, wherein the covering is arranged such that the uncovered area is a polygon.

5. A multi-mode cavity filter according to claim 1, wherein the covering is arranged such that the uncovered area is amorphous in shape.

6. A multi-mode cavity filter according to claim 1, wherein the cover is arranged to cover, of the face, only a peripheral frame thereof.

7. A multi-mode cavity filter according to claim 1, wherein at least a part of the covering is a coating on the resonator body.

8. A multi-mode cavity filter according to claim 1, wherein at least a part of the covering is a layer on an object placed next to the resonator body.

9. A multi-mode cavity filter according to claim 8, wherein the object is a printed circuit board.

10. A multi-mode cavity filter according to claim 1, further comprising a coupling structure within the uncovered area and arranged to couple said signal between the body and a conductor external to the body.

11. A multi-mode cavity filter according to claim 10, wherein said coupling structure is coated onto the body or onto an object placed against the uncovered area.
